(19) United States
(12) Patent Application Publication
(10) Pub. No.: US 2012/0207109 A1
(43) Pub. Date: Aug. 16, 2012

(54) Multiplexing of ACK/NACK and channel state information on uplink control channel

(75) Inventors: Kari P. PAJUKOSKI, Oulu (FI); Kari J. HOOLI, Oulu (FI); Esa TIIROLA, Kempele (FI); Timo LUNTTILA, Espoo (FI)

(73) Assignee: Nokia Siemens Networks Oy

(21) Appl. No.: 13/385,353

(22) Filed: Feb. 14, 2012

Related U.S. Application Data
(60) Provisional application No. 61/463,310, filed on Feb. 14, 2011.

(51) Int. Cl. H04W 72/04

(52) U.S. Cl. 370/329

(57) ABSTRACT

A method, apparatus and computer program which enable simultaneous transmission of a positive or negative acknowledge and channel state information and spatially bundle the positive or negative acknowledge bits corresponding to multiple transport blocks for each of a plurality of component carriers, where if there are two positive or negative acknowledge bits on a carrier component a logical “AND” operation is applied to bundle the two positive and negative acknowledge bits.

### TECHNICAL FIELD

The exemplary and non-limiting embodiments of this invention relate generally to wireless communication systems, methods, devices and computer programs and, more specifically, relate to uplink control channel signaling techniques.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
ACK (A) acknowledgment
BPSK binary phase shift keying
BS base station
CA carrier aggregation
CAZAC constant amplitude zero autocorrelation
CIF carrier indicator field
CC component carrier
CP cyclic prefix
CQI channel quality indicator
CSI channel state information
CW codeword
DAI downlink assignment indicator
DL downlink (eNB towards UE)
DTX discontinuous transmission
eNB E-UTRAN Node B (evolved Node B)
EPC evolved packet core
E-UTRAN evolved UTRAN (LTE)
FDMA frequency division multiple access
HARQ hybrid automatic repeat request
IMTA international mobile telecommunications association
ITU-R international telecommunication union-radiocommunication sector
LTE long term evolution of UTRAN (E-UTRAN)
LTE-A LTE advanced
MAC medium access control (layer 2, L2)
MM/MME mobility management/mobility management entity
NACK (N) negative acknowledgment
NodeB base station
OFDMA orthogonal frequency division multiple access
O&M operations and maintenance
PCC primary component carrier
PCell primary cell
PDCP packet data convergence protocol
PDSCH physical downlink shared channel
PHY physical (layer 1, L1)
PMI precoding matrix indicator
PUCCH physical uplink control channel
QPSK quadrature phase shift keying
Rel release
RI rank indicator
RLC radio link control
RRC radio resource control
RRM radio resource management
RS reference signal
SCC secondary component carrier
SCell secondary cell
SGW serving gateway
SC-FDMA single carrier, frequency division multiple access
TDD time division duplexing
UE user equipment, such as a mobile station, mobile node or mobile terminal
UL uplink (UE towards eNB)
UPE user plane entity
UTRAN universal terrestrial radio access network

Uplink control channel signaling techniques have been investigated by the 3rd Generation Partnership Project (3GPP) in the Technical Specification Group Radio Access Network (TSG RAN) in support of the progression of the long term evolution advanced (LTE-Advance or LTE-A) standard. These ongoing efforts across the industry are aimed at identifying technologies and capabilities that can improve systems such as air interface of the universal mobile telecommunication system (“UMTS”) so-called evolved UMTS Terrestrial Radio Access Network (E-UTRAN, also referred to as UTRAN-LTE or as E-UTRA). In this system, the downlink (DL) access technique is orthogonal frequency division multiple access (OFDMA), and the uplink (UL) access technique is single carrier, frequency division multiple access (SC-FDMA). A short description and references to the relevant portions of the UTRAN and the LTE and LTE-A specifications are set forth below.

Long Term Evolution, Release 8 (LTE Rel-8) as known by those familiar and skilled in the art is generally described in 3GPP TS 36.300, V8.11.0 (2009-12), 3rd Generation Partnership Project; Technical Specification Group Radio Access Network; Evolved Universal Terrestrial Radio Access (E-UTRA) and Evolved Universal Terrestrial Access Network (EUTRAN); Overall description; Stage 2 (Release 8). An additional set of specifications given generally as 3GPP TS 36.xyz (e.g., 36.211, 36.311, 36.312, etc.) may be seen as describing the Release 8 LTE system. More recently, LTE Release 9 and LTE-A Release 10 versions of at least some of these specifications have been published including 3GPP TS 36.300, V10.2.0 (2010-12).

FIG. 1(a) reproduces FIG. 4.1 of 3GPP TS 36.300 and shows the overall architecture of the E-UTRAN system (Rel-8) 1. The E-UTRAN system includes three eNBs which provide the E-UTRAN user plane (PDCP/RLC/MAC/PHY) and control plane (RRC) protocol terminations towards the UEs. The eNBs are interconnected with each other by means of an X2 interface. The X2 “connection” shown in FIG. 1(a) is logical in nature. In other words, the architecture depicted in FIG. 1(a) is shown as a direct connection between eNodeB's, but in various implementations X2 connections may be physically routed through transport connections similar to the two S1 interface connections shown. The eNBs are also connected by means of an S1 interface to an EPC, more specifically to a MME by means of a S1 MME interface and to a S-GW by means of a S1 interface (MME/S-GW 4). As also shown in FIG. 1(a), the S1 interface supports a many-to-many relationship between MMEs/S-GWs/UPEs and eNBs.

The eNB hosts the following functions:
functions for remote radio management/control (RRM and RRC), Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MME or O&M); and
a measurement and measurement reporting configuration for mobility and scheduling.

Additional reference is made to the Long Term Evolution-Advanced, Release 10 (LTE-A Rel-10) which targeted towards future UMTA systems, referred to herein for convenience simply as LTE-Advanced (LTE-A). As known by those familiar and skilled in the art, reference in this regard may be made to 3GPP TR 36.913, V9.0.0 (2009-12), 3rd Generation Partnership Project; Technical Specification Group Radio Access Network; Requirements for Further Advancements for E-UTRA (LTE-Advanced) (Release 9). Reference can also be made to 3GPP TR 36.912 V9.3.0 (2010-06) Technical Report 3rd Generation Partnership Project; Technical Specification Group Radio Access Network; Feasibility study for Further Advancements for E-UTRA (LTE-Advanced) (Release 9).

A goal of LTE-A is to provide significantly enhanced services by means of higher data rates and lower latency with reduced cost. LTE-A is directed toward extending and optimizing the 3GPP LTE Rel-8 radio access technologies to provide higher data rates at lower cost. LTE-A will be a more optimized radio system fulfilling the International Telecommunication Union Radiocommunication Sector (ITU-R) requirements for IMT-Advanced while keeping the backward compatibility with LTE Rel-8.

As known by those familiar and skilled in the art as set forth in 3GPP TR 36.913, LTE-A should operate in spectrum allocations of different sizes, including wider spectrum allocations than those of LTE Rel-8 (e.g., up to 100 MHz) to achieve the peak data rate of 100 Mbit/s for high mobility and 1 Gbit/s for low mobility. It has been agreed that carrier aggregation (CA) is to be considered for LTE-A in order to support bandwidths larger than 20 MHz. Carrier aggregation, where two or more component carriers (CCs) are aggregated, is considered for LTE-A in order to support transmission bandwidths larger than 20 MHz. The carrier aggregation could be contiguous or non-contiguous. This technique, as a bandwidth extension, can provide significant gains in terms of peak data rate and cell throughput as compared to non-aggregated operation as in LTE Rel-8.

A terminal may simultaneously receive one or multiple component carriers depending on its capabilities. A LTE-A terminal with reception capability beyond 20 MHz can simultaneously receive transmissions on multiple component carriers. A LTE Rel-8 terminal can receive transmissions on a single component carrier only, provided that the structure of the component carrier follows the Rel-8 specifications. Moreover, it is required that LTE-A should be backwards compatible with Rel-8 LTE in the sense that a Rel-8 LTE terminal should be operable in the LTE-A system, and that a LTE-A terminal should be operable in a Rel-8 LTE system.

FIG. 1(b) shows an example of the carrier aggregation 2, where M Rel-8 component carriers are combined together to form M times Rel-8 BW (e.g. 5×20 MHz=100 MHz given M=5). Rel-8 terminals receive/transmit on one component carrier, whereas LTE-A terminals may receive/transmit on multiple component carriers simultaneously to achieve higher (wider) bandwidths.

In LTE-A with carrier aggregation security input and non-access stratum (NAS) mobility information is received by the UE from one serving cell known as the primary serving cell (PCell). All other serving cells are referred to as secondary serving cells (SCells). UL/DL carrier corresponding to the PCell is referred to as the primary CC (PCC) and the UL/DL carrier corresponding to the SCell is referred to as the secondary CC (SCC). In the PCell system, information is monitored as in Rel-8. Relevant system information of configured SCells is obtained via dedicated signaling.

Of particular interest herein are aspects of positive and negative acknowledge (ACK/NACK) and CSI transmission on the physical uplink control channel (PUCCH), and in particular in the case of carrier aggregation.

### SUMMARY

In a first exemplary embodiment of the invention there is a method comprising the step of enabling simultaneously transmission of a positive or negative acknowledge and channel state information. Thereafter spatial bundling of the positive or negative acknowledge bits corresponding to multiple transport blocks is applied for each of a plurality of component carriers. If there are two positive or negative acknowledge bits on a carrier component a logical “AND” operation is applied to bundle the two positive and negative acknowledge bits.

In a second exemplary embodiment of the invention there is an apparatus comprising at least one processor and at least one memory storing a computer program. In this embodiment the at least one memory with the computer program is configured with the at least one processor to cause the apparatus to at least enable simultaneous transmission of a positive or negative acknowledge and channel state information. Thereafter spatial bundling of the positive or negative acknowledge bits corresponding to multiple transport blocks is applied for each of a plurality of component carriers. If there are two positive or negative acknowledge bits on a carrier component a logical “AND” operation is applied to bundle the two positive and negative acknowledge bits.

In a third exemplary embodiment there is a computer readable memory storing a computer program, in which the computer program enables simultaneously transmission of a positive or negative acknowledge and channel state information. Thereafter spatial bundling of the positive or negative acknowledge bits corresponding to multiple transport blocks is applied for each of a plurality of component carriers. If there are two positive or negative acknowledge bits on a carrier component a logical “AND” operation is applied to bundle the two positive and negative acknowledge bits.

In a fourth exemplary embodiment of the invention there is an apparatus comprising means for enabling simultaneous transmission of a positive or negative acknowledge and channel state information and means for spatially bundling positive or negative acknowledge bits corresponding to multiple transport blocks for each of a plurality of component carriers, where if there are two positive or negative acknowledge bits on a carrier component a logical “AND” operation is applied to bundle the two positive and negative acknowledge bits.

These and other embodiments and aspects are detailed below with particularity.

### BRIEF DESCRIPTION OF THE DRAWINGS

The following discussion of the exemplary embodiments of this invention is made more evident in the following Detailed Description, when read in conjunction with the attached Drawing Figures, wherein:

FIG. 1(a) reproduces FIG. 4.1 of 3GPP TS 36.300, and shows the overall architecture of the EUTRAN system.

FIG. 1(b) shows an example of carrier aggregation as proposed for the LTE-A system;

FIG. 1(c) depicts mapping of modulation symbols for the physical uplink control channel;

FIG. 1(d) shows a sequence modulator and a following CP block for transmitting 1-bit or 2-bit ACK/NACK indications;

FIG. 2 shows a simplified block diagram of various electronic devices that are suitable for use in practicing the exemplary embodiments of this invention;

FIG. 3 illustrates a constellation map depicting the application of a bundling rule for ACK/NACK bits from different CCs according to one exemplary embodiment of the invention;

FIG. 4 illustrates an alternative option for the case of ACK/NACK bundling over the cells, where the ‘AND’ logical operation of Table 1.12 is replaced by cross-CC bundling; and

FIG. 5 is a logic flow diagram that illustrates the operation of a method, and a result of execution of computer program instructions embodied on a computer readable memory, in accordance with the exemplary embodiments of this invention.

### DETAILED DESCRIPTION

The exemplary embodiments of this invention provide apparatus, methods, and computer program(s) for simultaneous transmission of ACK/NACK and CSI using spatial bundling of ACK/NACK bits corresponding to multiple transport blocks relating to a plurality of component carriers for use in carrier aggregation. A short description and references to the relevant portions of the UTRAN and LTE-A specifications are set forth below, prior to a detailed description of the exemplary embodiments of this invention.

1. PUCCH Structure

The physical uplink control channel (PUCCH) which carries uplink control information in LTE/LTE-A networks is familiar and known by those skilled in the art as described in 3GPP TS 36.211 V10.0.0 (2010-12) Technical Specification 3rd Generation Partnership Project; Technical Specification Group Radio Access Network; Evolved Universal Terrestrial Radio Access (E-UTRA); Physical channels and modulation (Release 10) [hereinafter “3GPP TS 36.211”]. Uplink control includes hybrid automatic repeat request (“HARQ”) acknowledgements (i.e. ACK/NACK) related to data packets received in the downlink, channel quality indicators (CQIs) to support link adaptation and MIMO feedback such as rank indicators (RIs) and precoding matrix indicators (PMI) for downlink transmissions as well as scheduling requests (SRs) for uplink transmissions.

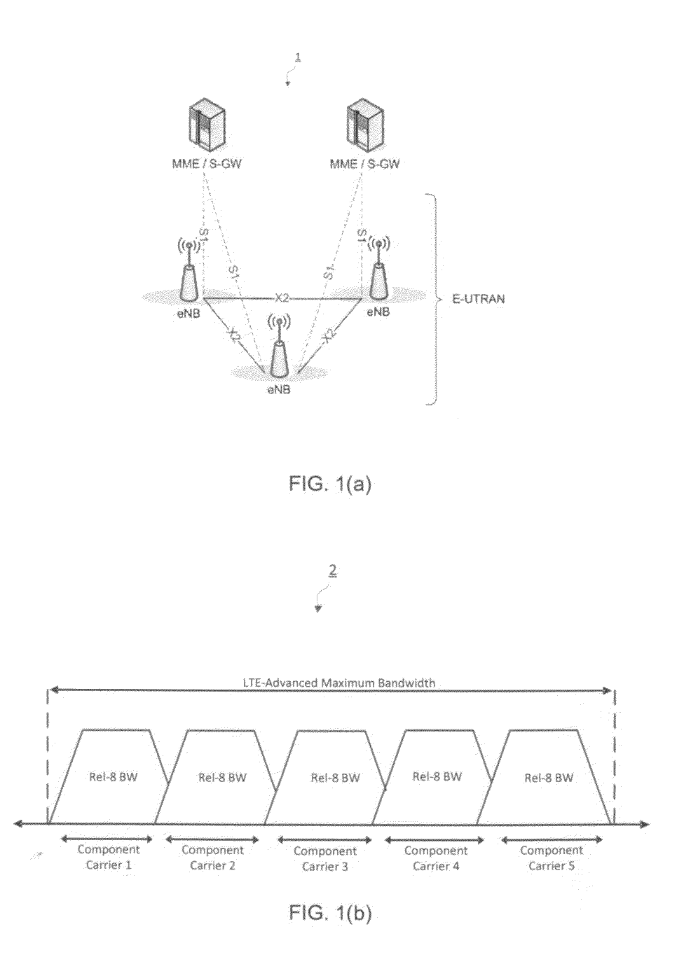

To maximize frequency diversity and retain its single-carrier property, PUCCH resources are typically allocated at the edges of the UL channel bandwidth. An example of mapping logical PUCCH resource blocks into physical PUCCH resource blocks is shown in FIG. 1(c). Logical resource blocks, denoted as m are mapped to each 0.5 ms slot within a 1 ms subframe. Two consecutive slots each contain resource blocks (RBs) with a capacity of twelve sub-carriers. One PUCCH RB per transmission can relate to an individual UE and is located at one end of UL channel bandwidth followed by a PUCCH RB pair in the following slot at the opposite end of the channel spectrum thus making use of frequency diversity.

(a) PUCCH Formats

The physical uplink control channel supports multiple formats as shown below in Table 1.1. PUCCH format 1, 1a, and 1b is based on the combination of constant amplitude zero autocorrelation (CAZAC) sequence modulation and block-wise spreading whereas 2, 2a, and 2b use only CAZAC sequence modulation. As a result, PUCCH format 1, 1a and 1b can only carry one information symbol (1 or 2 bits) per slot while PUCCH formats 2, 2a and 2b are capable of conveying 5 symbols per slot (20 coded bits+ACK/NACK per subframe). PUCCH format 3 is designed to carry large payloads by employing orthogonal spreading followed by transform coding. The orthogonal sequences are a discrete Fourier transform (DFT) of length five which allows multiplexing up to five PUCCH format 3 transmissions in the same RB.

TABLE 1.1
Supported PUCCH formats.

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |
| 3 | QPSK | 48 |

All PUCCH formats use a cell-specific cyclic shift, n_{cs}^{cell}(nₛ,l), which varies with the symbol number l and the slot number nₛ according to n_{cs}^{cell}(nₛ,l)=Σᵢ₌₀⁷c(8N_{symb}^{UL}·nₛ8l+i)·2ⁱ where the pseudo-random sequence c(i) is defined by section 7.2 of 3GPP TS 36.211 as familiar and known by those skilled in the art. The pseudo-random sequence generator is initialized with cᵢₙᵢₜ=N_{ID}^{cell} corresponding to the primary cell at the beginning of each radio frame.

Physical resources used for PUCCH depends on two parameters, N_{RB}⁽²⁾ and N_{cs}⁽¹⁾, given by higher layers. The variable N_{RB}⁽²⁾≧0 denotes the bandwidth in terms of resource blocks that are available for use by PUCCH formats 2/2a/2b transmission in each slot. The variable N_{cs}⁽¹⁾ denotes the number of cyclic shift used for PUCCH formats 1/1a/1b in a resource block used for a mix of formats 1/1a/1b and 2/2a/2b. The value of N_{cs}⁽¹⁾ is an integer multiple of Δ_{shift}^{PUCCH} within the range of {0, 1, . . . , 7}, where Δ_{shift}^{PUCCH} is provided by higher layers. No mixed resource block is present if N_{cs}⁽¹⁾=0. At most one resource block in each slot supports a mix of formats 1/1a/1b and 2/2a/2b. Resources used for transmission of PUCCH formats 1/1a/1b, 2/2a/2b and 3 are represented by the non-negative indices n_{PUCCH}^{(1,\tilde{p})},

$${n}_{PUCCH}^{( 2 )} < {N}_{RB}^{( 2 )} {N}_{sc}^{RB} + ⌈ \frac{{N}_{cs}^{( 1 )}}{8} ⌉ \cdot ( {N}_{sc}^{RB} - {N}_{cs}^{( 1 )} - 2 ) ,$$

and n_{PUCCH}^{(3,\tilde{p})} respectively.

(a) PUCCH Formats 1, 1a and 1b

As familiar and known to those skilled in the art, 3GPP TS 36.211 also describes formats for 1, 1a and 1b where PUCCH format 1 provides that information is carried by the presence/absence of transmission of PUCCH from the UE. In addition, d(0)=1 is assumed for PUCCH format 1. For PUCCH formats 1a and 1b, one or two explicit bits are transmitted, respectively. The block of bits b(0), . . . , b(M_{bit}−1) are modulated as described in Table 1.1, resulting in a complex-valued symbol d(0). The modulation schemes for the different PUCCH formats are given by Table 1.2.

TABLE 1.2
Modulation symbol d(0) for PUCCH formats 1a and 1b.

| PUCCH format | b(0), . . . , b(M_{bit} − 1) | d(0) |
|---|---|---|
| 1a | 0 | 1 |
| | 1 | −1 |
| 1b | 00 | 1 |
| | 01 | −j |
| | 10 | j |
| | 11 | −1 |

(b) PUCCH Formats 2, 2a and 2b

For PUCCH formats 2, 2a and 2b, the block of bits b(0), . . . , b(19) are scrambled with a UE-specific scrambling sequence, resulting in a block of scrambled bits) \tilde{b}(0), . . . , \tilde{b}(19) according to \tilde{b}(i)=(b(i)+c(i))mod 2 where the scrambling sequence c(i) is given by Section 7.2 of 3GPP TS 36.211 which is familiar and known to those skilled in the art. The scrambling sequence generator is initialized with cᵢₙᵢₜ=(└nₛ/2┘1)·(2N_{ID}^{cell}+1)·2¹⁶+n_{RNTI} at the start of each subframe where n_{RNTI} is C-RNTI. The block of scrambled bits \tilde{b}(0), . . . , \tilde{b}(19) are QPSK modulated as described in Section 7.1 of 3GPP TS 36.211, resulting in a block of complex-valued modulation symbols d(0), . . . , d(9).

For PUCCH formats 2a and 2b, supported for normal cyclic prefix only, the bit(s) b(20), . . . , b(M_{bit}−1) is modulated as described in Table 1.5 resulting in a single modulation symbol d(10) used in the generation of the reference-signal for PUCCH format 2a and 2b as described in Section 5.5.2.2.1 of 3GPP TS 36.211.

TABLE 1.5
Modulation symbol d(10) for PUCCH formats 2a and 2b.

| PUCCH format | b(20), . . . , b(M_{bit} − 1) | d(10) |
|---|---|---|
| 2a | 0 | 1 |
| | 1 | −1 |
| 2b | 00 | 1 |
| | 01 | −j |
| | 10 | j |
| | 11 | −1 |

(c) PUCCH Format 3

In PUCCH format 3, the block of bits b(0), . . . , b(M_{bit}−1) are scrambled with a UE-specific scrambling sequence, resulting in a block of scrambled bits \tilde{b}(0), . . . , \tilde{b}(M_{bit}−1) according to \tilde{b}(i)=(b(i)+c(i))mod 2 where the scrambling sequence c(i) is given by Section 7.2 of 3GPP TS 36.211. The scrambling sequence generator is initialized with cᵢₙᵢₜ=(└nₛ/2┘1)·(2N_{ID}^{cell}+1)·2¹⁶+n_{RNTI} at the start of each subframe where n_{RNTI} is the C-RNTI.

The block of scrambled bits \tilde{b}(0), . . . , b(M_{bit}−1) are QPSK modulated as described in Section 7.1 of 3GPP TS 36.211, resulting in a block of complex-valued modulation symbols where d(0), . . . , d(M_{symb}−1) where M_{symb}=M_{bit}/2=2N_{sc}^{RB}.

2. Mapping to Physical Resources

According to 3GPP TS 36.211, the block of complex-valued symbols z^{(\tilde{p})}(i) is multiplied with the amplitude scaling factor β_{PUCCH} in order to conform to the transmit power P_{PUCCH} specified in Section 5.1.2.1 of 3GPP TS 36.211 in [4], and mapped in sequence starting with z^{(\tilde{p})}(0) to resource elements. PUCCH uses one resource block in each of the two slots in a subframe. Within the physical resource block used for transmission, the mapping of z^{(\tilde{p})}(i) to resource elements (k,l) on antenna port p and not used for transmission of reference signals shall be in increasing order of first k, then l and finally the slot number, starting with the first slot in the subframe. The relation between the index \tilde{p} and the antenna port number P is given by Table 1.6 (Uplink resource grid).

TABLE 1.6
The antenna ports used for different physical channels and
signals.

| | | Antenna port number ^{p} as a function of | | |
|---|---|---|---|---|
| | | the number of antenna ports configured | | |
| Physical channel | | for the respective physical channel/signal | | |
| or signal | Index ^{\tilde{p}} | 1 | 2 | 4 |
| PUSCH | 0 | 10 | 20 | 40 |
| | 1 | — | 21 | 41 |
| | 2 | — | — | 42 |
| | 3 | — | — | 43 |
| SRS | 0 | 10 | 20 | 40 |
| | 1 | — | 21 | 41 |
| | 2 | — | — | 42 |
| | 3 | — | — | 43 |
| PUCCH | 0 | 100 | 200 | — |
| | 1 | — | 201 | — |

The physical resource blocks to be used for transmission of PUCCH in slot nₛ are given by

$${n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix}$$

where the variable m depends on the PUCCH format. For formats 1, 1a and 1b

$$m = \{ \begin{matrix}{N}_{RB}^{( 2 )} & if {n}_{PUCCH}^{( 1 , \tilde{p} )} < c \cdot \frac{{N}_{cs}^{( 1 )}}{{Δ}_{shift}^{PUCCH}} \\ ⌊ \frac{{n}_{PUCCH}^{( 1 , \tilde{p} )} - c \cdot {N}_{cs}^{( 1 )} / {Δ}_{shift}^{PUCCH}}{c \cdot {N}_{sc}^{RB} / {Δ}_{shift}^{PUCCH}} ⌋ + {N}_{RB}^{( 2 )} + ⌈ \frac{{N}_{cs}^{( 1 )}}{8} ⌉ & otherwise\end{matrix} \\ c = \{ \begin{matrix}3 & normal cyclic prefix \\ 2 & extended cyclic prefix\end{matrix}$$

and for formats 2, 2a and 2b

m=└n_{PUCCH}^{(2,\tilde{p})}/N_{sc}^{RB}┘

and for format 3

m=└n_{PUCCH}^{(3,\tilde{p})}/N_{SF,0}^{PUCCH}┘.

As mentioned above, mapping of modulation symbols for the physical uplink control channel is illustrated in FIG. 1(c). In case of simultaneous transmission of sounding reference signal and PUCCH format 1, 1a, 1b or 3 when there is one serving cell configured, a shortened PUCCH format is used where the last SC-FDMA symbol in the second slot of a subframe is left empty.

3. UE Procedure for Reporting CQI, PMI and RI

The time and frequency resources that can be used by the UE to report channel quality indication (CQI), precoding matrix indicator (PMI) and rank indication (RI) are controlled by the eNB. The CQI indicates an index of a modulation/coding scheme that could be received on the Physical Downlink Shared Channel (PDSCH) with a BLER ≦0.1. The PMI indicates the preferred precoding matrix for PDCH while RI indicates the number of useful transmission layers for PDSCH. CQI, PMI and RI reporting is periodic on PUCCH (i.e. wideband or UE-selected subband) or aperiodic on PUCCH (i.e. triggered by 1 bit in PDCCH message, wideband, UE-selected subband or higher-layer configured subband). A UE is configured with PMI/RI reporting depending on the configured transmission mode (TM) (i.e. TM 0-9). As familiar and known to those skilled in the art, periodic reporting of CQI, PMI and RI as well as TMs associated with a UE configured for PMI/RI is described in Section 7.2 of 3GPP TS 36.213 V10.0.1 (2010-12) Technical Specification 3rd Generation Partnership Project; Technical Specification Group Radio Access Network; Evolved Universal Terrestrial Radio Access (E-UTRA); Physical layer procedures (Release 10).

4. UE Procedure for Reporting ACK/NACK.

For frequency division duplexing (FDD), when both ACK/NACK and scheduling requests (SRs) are transmitted in the same sub-frame, a UE transmits the ACK/NACK on its assigned ACK/NACK PUCCH resource for a negative SR transmission and transmit the ACK/NACK on its assigned SR PUCCH resource for a positive SR transmission. Each positive acknowledgement (NACK) is encoded as a binary ‘1’ and each negative acknowledgement (NAK) is encoded as a binary ‘0’.

For most UL:DL configurations in time division duplexing (TDD), two ACK/NACK feedback modes are supported by higher layer configuration: ACK/NACK bundling or ACK/NACK multiplexing. The exception being TDD UL-DL configuration 5 in which nine out of ten subframes inside a radio frame contain DL transmissions (i.e. single transmit antenna and two receive antennas) and only ACK/NACK bundling is supported.

ACK/NACK bundling generates a single ACK/NACK report based upon the assigned subframes within a set of associated subframes. The process of bundling involves associating each DL subframe with an UL subframe. The UL subframes are then associated with k subframes, where k can be zero, one or up to nine depending upon the asymmetry in the UL:DL configuration (or depending upon the TDD UL-DL configuration employed). For each UL subframe, ACK/NACKs from subframes with DL assignments within the set of associated subframes are combined. A single ACK/NACK report is generated based on the combination by using a logical “AND” operation to send a single ACK/NACK in an UL subframe.

ACK/NACK multiplexing feedback mode, involves up to four ACK/NACKs associated with up to four different DL subframes transmitted in an UL subframe. One bit feedback per DL subframe is allowed and spatial bundling is applied to generate a single ACK/NACK in case of MIMO transmission per DL subframe.

For TDD, the UE upon detection of a Physical Downlink Shared Channel (PDSCH) transmission or a Packet Data Control Channel (PDCCH) indicating downlink semi-persistent scheduling (SPS) release within subframe(s) n−k, where kεK and K is defined in Table 1.7 intended for the UE and for which ACK/NACK response shall be provided, transmit the ACK/NACK response in UL subframe n.

TABLE 1.7
Downlink association set index K: {k₀,k₁, . . . k_{M-1}} for TDD

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, | — | — | — | — | — | — | — |
| | | | 11, 6 | | | | | | | |
| 6 | — | — | 7 | 7 | 5 | — | — | 7 | 7 | — |

For TDD UL-DL configurations 1-6, the value of the Downlink Assignment Index (DAI) in DCI format 0, V_{DAI}^{UL}, detected by the UE according to Table 1.9 in subframe n−k′, where k′ is defined in Table 1.8, represents the total number of subframes with PDSCH transmissions and with PDCCH indicating downlink SPS release to the corresponding UE within all the subframe(s) n−k, where kεK. The value V_{DAI}^{UL} includes all PDSCH transmission with and without corresponding PDCCH within all the subframe(s) n−k. In case neither PDSCH transmission, nor PDCCH indicating the downlink SPS resource release is intended to the UE, the UE can expect that the value of the DAI in DCI format 0, V_{DAI}^{UL}, if transmitted, is set to 4.

For TDD UL-DL configurations 1-6, the value of the DAI in DCI format 1/1A/1B/1D/2/2A/2B denotes the accumulative number of PDCCH(s) with assigned PDSCH transmission(s) and PDCCH indicating downlink SPS release up to the present subframe within subframe(s) n−k, where kεK, and shall be updated from subframe to subframe. Denote V_{DAI}^{DL} as the value of the DAI in PDCCH with DCI format 1/1A/1B/1D/2/2A/2B detected by the UE according to Table 1.9 in subframe n−kₘ, where kₘ is the smallest value in the set K (defined in Table 1.8) such that the UE detects a DCI format 1/1A/1B/1D/2/2A/2B/2C.

For all TDD UL-DL configurations, U_{DAI} is denoted as the total number of PDCCH(s) with assigned PDSCH transmission(s) and PDCCH indicating downlink SPS release detected by the UE within the subframe(s) n−k, where kεK. N_{SPS} is denoted as the number of PDSCH transmissions without a corresponding PDCCH within the subframe(s) n−k, where kεK. N_{SPS} can be zero or one.

For TDD ACK/NACK bundling or ACK/NACK multiplexing and a subframe n with M=1, the UE generates one or two ACK/NACK bits by performing a logical “AND” operation per codeword across M DL subframes associated with a single UL subframe, of all the corresponding U_{DAI}+N_{SPS} individual PDSCH transmission ACK/NACKs and individual ACK in response to received PDCCH indicating downlink SPS release, where M is the number of elements in the set K defined in Table 10.1-1. The UE detects if at least one downlink assignment has been missed, and for the case that the UE is transmitting on PUSCH the UE also determines the parameter N_{bundled}. For TDD UL-DL configuration 0, N_{bundled} is 1 if UE detects the PDSCH transmission with or without corresponding PDCCH within the subframe n−k, where kεK the following detecting rules apply:
For the case that the UE is not transmitting on PUSCH in subframe n and TDD UL-DL configurations 1-6, if U_{DAI}>0 and V_{DAI}^{DL}≠U_{DAI}−1)mod 4+1, the UE detects that at least one downlink assignment has been missed.
For the case that the UE is transmitting on PUSCH and the PUSCH transmission is adjusted based on a detected PDCCH with DCI format 0 intended for the UE and TDD UL-DL configurations 1-6, if V_{DAI}^{UL}≠(U_{DAI}/+N_{SPS}−1)mod 4+1 the UE detects that at least one downlink assignment has been missed and the UE shall generate NACK for all codewords where N_{bundled} is determined by the UE as N_{bundled}=+2. If the UE does not detect any downlink assignment missing, N_{bundled} is determined by the UE as N_{bundled}=V_{DAI}^{UL}. UE shall not transmit ACK/NACK if U_{DAI}+N_{SPS}=0 and V_{DAI}^{UL}=4.
For the case that the UE is transmitting on PUSCH, and the PUSCH transmission is not based on a detected PDCCH with DCI format 0 intended for the UE and TDD UL-DL configurations 1-6, if U_{DAI}>0 and V_{DAI}^{DL}≠(U_{DAI}−1)mod 4+1, the UE detects that at least one downlink assignment has been missed and the UE shall generate NACK for all codewords. The UE determines N_{bundled}=(U_{DAI}+N_{SPS}) as the number of assigned subframes. The UE shall not transmit ACK/NACK if U_{DAI}+N_{SPS}=0.

For TDD ACK/NACK bundling, when the UE is configured by transmission mode 3, 4 or 8 defined in Section 7.1 of 3GPP TS 36.213 V10.0.1 (2010-12) ACK/NACK bits are transmitted on PUSCH, the UE does always generate two ACK/NACK bits assuming both codeword 0 and 1 are enabled. For the case that the UE detects only the PDSCH transmission associated with codeword 0 within the bundled subframes, the UE generates NACK for codeword 1.

TABLE 1.8
Value of Downlink Assignment Index

| | | Number of subframes with |
|---|---|---|
| | | PDSCH transmission and with |
| DAI | | PDCCH indicating DL SPS |
| MSB, LSB | V_{DAI}^{UL} or V_{DAI}^{DL} | release |
| 0, 0 | 1 | 1 or 5 or 9 |
| 0, 1 | 2 | 2 or 6 |
| 1, 0 | 3 | 3 or 7 |
| 1, 1 | 4 | 0 or 4 or 8 |

TABLE 1.9
Uplink association index k′ for TDD

| TDD UL/DL | DL subframe number n | | | | | | | | | |
|---|---|---|---|---|---|---|---|---|---|---|
| Configuration | 0 | 1 | 2 | 3 | 4 | 5 | 6 | 7 | 8 | 9 |

| | | | | | |
|---|---|---|---|---|---|
| 1 | 6 | 4 | | 6 | 4 |
| 2 | 4 | | | 4 | |
| 3 | 4 | 4 | 4 | | |
| 4 | 4 | 4 | | | |
| 5 | 4 | | | | |
| 6 | 7 | 7 | 5 | 7 | 7 |

For TDD ACK/NACK multiplexing and a subframe n with M>1, spatial ACK/NACK bundling across multiple codewords within a DL subframe is performed by a logical “AND” operation of all the corresponding individual ACK/NACKs. In case the UE is transmitting on PUSCH, the UE determines the number of ACK/NAK feedback bits O^{ACK} and the ACK/NACK feedback bits oₙ^{ACK}, n=0, . . . , O^{ACK}−1 to be transmitted in subframe n in case the UE is transmitting on PUSCH. The following detection rules apply:
If the PUSCH transmission is adjusted based on a detected PDCCH with DCI format 0 intended for the UE, then O^{ACK}=V_{DAI}^{UL} unless V_{DAI}^{UL}=4 and U_{DAI}+N_{SPS}=0 in which case the UE does not transmit ACK/NACK. The spatially bundled ACK/NACK for a PDSCH transmission with a corresponding PDCCH or for a PDCCH indicating downlink SPS release in subframe n−k is associated with o_{DAI(k)-1}^{ACK}, where DAI(k) is the value of DAI in DCI format 1A/1B/1D/1/2/2A/2B detected in subframe n−k. For the case with N_{SPS}>0, the ACK/NACK associated with a PDSCH transmission without a corresponding PDCCH is mapped to o_{O}_{^{ACK}}₁^{ACK}. The ACK/NACK feedback bits without any detected PDSCH transmission or without detected PDCCH indicating downlink SPS release are set to NACK.
If the PUSCH transmission is not adjusted based on a detected PDCCH with DCI format 0 intended for the UE, O^{ACK}=M, and oᵢ^{ACK} is associated with the spatially bundled ACK/NACK for DL subframe n−kᵢ, where kᵢεK. The ACK/NACK feedback bits without any detected PDSCH transmission or without detected PDCCH indicating downlink SPS release are set to NACK. The UE shall not transmit ACK/NACK if U_{DAI}+N_{SPS}=0.

For TDD when both ACK/NACK and SR are transmitted in the same sub-frame, a UE shall transmit the bundled ACK/NACK or the multiple ACK/NAK responses (according to section 10.1) on its assigned ACK/NACK PUCCH resources for a negative SR transmission. For a positive SR, the UE shall transmit b(0),b(1) on its assigned SR PUCCH resource using PUCCH format 1b according to section 5.4.1 in [3]. The value of b(0),b(1) are generated according to Table 1.10 from the U_{DAI}+N_{SPS} ACK/NACK responses including ACK in response to PDCCH indicating downlink SPS release by spatial ACK/NAK bundling across multiple codewords within each PDSCH transmission. For TDD UL-DL configurations 1-6, if U_{DAI}>0, and V_{DAI}^{DL}≠(U_{DAI}−1)mod 4+1, the UE detects that at least one downlink assignment has been missed.

TABLE 1.10
Mapping between multiple ACK/NACK responses and
b(0), b(1)

| Number of ACK among multiple (U_{DAI} + N_{SPS}) | |
|---|---|
| ACK/NACK responses | b(0), b(1) |
| 0 or None (UE detect at least one DL | 0, 0 |
| assignment is missed) | |
| 1 | 1, 1 |
| 2 | 1, 0 |
| 3 | 0, 1 |
| 4 | 1, 1 |
| 5 | 1, 0 |
| 6 | 0, 1 |
| 7 | 1, 1 |
| 8 | 1, 0 |
| 9 | 0, 1 |

For TDD when both ACK/NACK and CQI/PMI or RI are configured to be transmitted in the same sub-frame on PUCCH, a UE shall transmit CQI/PMI or RI and b(0),b(1) using PUCCH format 2b for normal CP or PUCCH format 2 for extended CP, according to section 5.2.3.4 in 3GPP TS 36.212 V10.0.0 (2010-12) with a₀″,a₁″ replaced by b(0),b(1). The value of b(0),b(1) are generated according to Table 1.10 from the U_{DAI}+N_{SPS} ACK/NACK responses including ACK in response to PDCCH indicating downlink SPS release by spatial ACK/NACK bundling across multiple codewords within each PDSCH transmission. For TDD UL-DL configurations 1-6, if U_{DAI}>0 and V_{DAI}^{DL}≠(U_{DAI}−1)mod 4+1, the UE detects that at least one downlink assignment has been missed.

When only ACK/NACK or only a positive SR is transmitted a UE uses PUCCH Format 1a or 1b for the ACK/NACK resource and PUCCH Format 1 for the SR resource as defined in section 5.4.1 in 3GPP TS 36.211 V10.0.0 (2010-12) described above and shown in Table 1.1.

Further, configuration of radio resource control information elements for ACK/NACK, for channel coding for uplink control information is familiar and known to those skilled in the art and is described in 3GPP TS 36.212 V10.0.0 (2010-12) Technical Specification 3rd Generation Partnership Project; Technical Specification Group Radio Access Network; Evolved Universal Terrestrial Radio Access (E-UTRA); Multiplexing and channel coding (Release 10). Furthermore, Section 5.2.3 describes uplink control information on PUCCH. Likewise, Section 6.3.2 in 3GPP TS 36.331 V10.0.0 (2101-12) as familiar and known to those skilled in the art, describes the coding language for radio resource control information elements.

During the 3GPP TSG RAN WG1 Meeting #63, R1-106193, Jacksonville, USA, 15-19 Nov., 2010 (Agenda item: 6.2.1.1), Nokia Siemens Networks presented a document for discussion entitled “Remaining details for PUCCH A/N (FDD).” That document which is familiar and known to those skilled in the art addressed resource allocation and PUCCH multiplexing combinations. Resource allocations including the need for ACK/NACK resource indicator (ARI), resource allocation for the 2nd ACK/NACK resource in the case of dual-CW and channel selection, PUCCH format 3 indexing and further ARI details. Discussions of PUCCH multiplexing combinations included support for cross-carrier ACK/NACK bundling (without DAI bits) with CQI in the case of channel selection or the multiplexing scheme could be based on the Rel-8 TDD approach discussed above.

The exemplary embodiments of this invention are concerned at least in part with a case where carrier aggregation ACK/NACK signals coincide with CSI (channel state information, which contains CQI, PMI and RI). A problem that arises in this scenario is enabling simultaneous transmission of ACK/NACK and CSI when the UE is configured, in LTE-Advanced CA, to perform ACK/NACK feedback using either PUCCH format 1b channel selection or PUCCH format 3. In LTE Release-8, Rel-9, and Rel-10 the PUCCH format 2 is used to carry CSI. Prior to the RAN WG#1 meeting noted above, it was agreed that PUCCH format 1b with channel selection is to be used for Rel-10 UEs that support up to four ACK/NACK bits, while PUCCH format 3 can be supported for payload sizes of up to 20 bits.

As mentioned above, PUCCH format 2a and 2b in LTE Release-8 are configured for carrying ACK/NACK bits (1 bit with format 2a, 2 bits with format 2b) when multiplexed with CSI on the PUCCH. Two different approaches were selected for signaling the ACK/NACK and CQI on PUCCH (Format 2a/2b). In a first approach, referred to as Normal CP, the ACK/NACK information is modulated in the second CQI reference signals of the slot. The resource signal (RS) modulation follows the constant amplitude zero autocorrelation (CAZAC) sequence modulation principle as discussed above and shown in FIG. 1(d) which is a block diagram of a sequence modulator configured to transmit periodic CQI on PUCCH. In PUCCH formats 2a and 2b the information concerning 1-bit or 2-bit ACK/NACK is transmitted by modulating the second RS block with BPSK or QPSK, respectively.

In the second approach, referred to as Extended CP, the ACK/NACK bits and the CQI bits are jointly coded, and no information is embedded in any of the CQI reference signals. The main reason for using different approaches for the normal and extended CP lengths was that in extended CP there is only one reference signal (RS) block per slot and hence the method used with the normal CP cannot be utilized.

Support of PUCCH format 2a/2b is made configurable in the LTE UL system. In order to guarantee ACK/NACK coverage, the eNodeB can configure a UE to drop (not transmit) the CQI in the case when ACK/NACK and CQI would appear in the same subframe on PUCCH. In this configuration, PUCCH format 1a/1b is used instead of format 2a/2b.

Discussed now is channel selection in LTE Rel-10. It is apparent that new ACK/NACK multiplexing solutions are needed in Rel-10 due to the increased number of ACK/NACK bits resulting from DL carrier aggregation. Also, for carrier aggregation, the UL control signaling (HARQ ACK/NACK signaling, SR and CSI) has to support up to five downlink carrier components as shown in FIG. 1(b). In LTE Rel-10, in the case of up to four ACK/NACK bits, channel selection can be used. The basic idea in channel selection is that multiple ACK/NACK channels are assigned to the UE and the UE selects the channel and the modulation constellation point for transmission based on the ACK/NACK values it is reporting.

LTE Rel-8/9 supports multiple multiplexing options between ACK/NACK and CSI based on, for example, PUCCH formats 2a and 2b. For backwards compatibility, it would be beneficial to support at least the same multiplexing options in LTE-Advanced with carrier aggregation, regardless of the increased ACK/NACK payload size. This approach would avoid unnecessary scheduling restrictions and allow for maximizing the DL throughput in all cases.

Preferably the multiplexing design should minimize the need for signal dropping in the case of collisions in general. On the other hand, proper configurability and maximal reuse of existing signaling should be supported as well. Hence, an option of dropping CSI when a collision occurs with (multi-)ACK/NACKs should be supported in a similar manner to LTE Rel-8.

As mentioned above, it was decided in RAN1#62 that neither DAI (Downlink Assignment Indicator) nor carrier domain bundling is supported in FDD CA. However, it was not agreed whether this decision is applicable to channel selection with simultaneous CQI on PUCCH. Accordingly, there are no multiplexing solutions for ACK/NACK plus CSI on the PUCCH that would fulfill the following criteria:
(a) no cross-CC bundling;
(b) support for channel selection without CSI dropping; and
(c) support for PUCCH format 3 without joint coding of (multi-)ACK/NACK and CSI.

In one exemplary embodiment of the invention a multiplexing scheme is based on the Rel-8 TDD approach. In this approach, the information on the number of ACKs is included in the bundled ACK/NACK feedback message according to Table 7.3-1 of 3GPP TS 36.213, shown above as Table 1.10. When both ACK/NACK and CQI/PMI or RI are configured to be transmitted in the same sub-frame on the PUCCH the UE transmits CQI and b(0), b(1) using PUCCH format 2b for normal CP or PUCCH format 2 for extended CP, according to section 5.2.3.4 in 3GPP TS 36.212 with a(0), a(1) replaced by b(0), b(1). The value of b(0), b(1) are generated according to Table 7.3-1 (Table 1.10) from the ACK/NACK responses by use of spatial ACK/NACK bundling across multiple codewords within each PDSCH transmission.

In particular, according to Section 5.2.3, When normal CP is used for UL transmission, the CQI is coded according to section 5.2.3.3 in 3GPP TS 36.212 with input bit sequence a₀′, a₁′, a₂′, a₃′, . . . , a_{A′-1}′ and output bit sequence b₀′, b₁′, b₂′, b₃′, . . . , b_{B′-1}′, where B=20. The HARQ-ACK bits are denoted by a₀″ in case one HARQ-ACK bit or a₀″,a₁″ in case two HARQ-ACK bits are reported per subframe. Each positive acknowledgement (NACK) is encoded as a binary ‘1’ and each negative acknowledgement (NAK) is encoded as a binary ‘0’.

The output of this channel coding block for normal CP is denoted by b₀, b₁, b₂, b₃, . . . , b_{B-1}, where bᵢ=bᵢ′, i=0, . . . , B′−1

In case one HARQ-ACK bit is reported per subframe:

b_{B′}=a₀″ and B=(B′+1)

In case two HARQ-ACK bits are reported per subframe:

b_{B′}=a₀″,b_{B′+1}=a₁″ and B=(B′+2)

When extended CP is used for UL transmission, the CQI and the HARQ-ACK bits are jointly coded. The HARQ-ACK bits are denoted by a₀″ in case one HARQ-ACK bit or [a₀″,a₁″] in case two HARQ-ACK bits are reported per subframe. The channel quality information denoted by a₀′, a₁′, a₂′, a₃′, . . . , a_{A′-1}′ is multiplexed with the HARQ-ACK bits to yield the sequence a₀′, a₁′, a₂′, a₃′, . . . , a_{A-1}′ as follows aᵢ=aᵢ′, i=0, . . . , A′−1 and a_{A′}=a₀″ and A=(A′+1) in case one HARQ-ACK bit is reported per subframe, or a_{A′}=a₀″, and A=(A′+2) in case two HARQ-ACK bits are reported per subframe. The sequence a₀, a₁, a₂, a₃, . . . , a_{A-1} is encoded according to section 5.2.3.3 to yield the output bit sequence b₀, b₁, b₂, b₃, . . . , b_{B-1} where B=20.

However, one potential problem that could arise with this approach is the reliance on cross-carrier component ACK/NACK bundling which could affect overall performance especially in the case of inter-band CA.

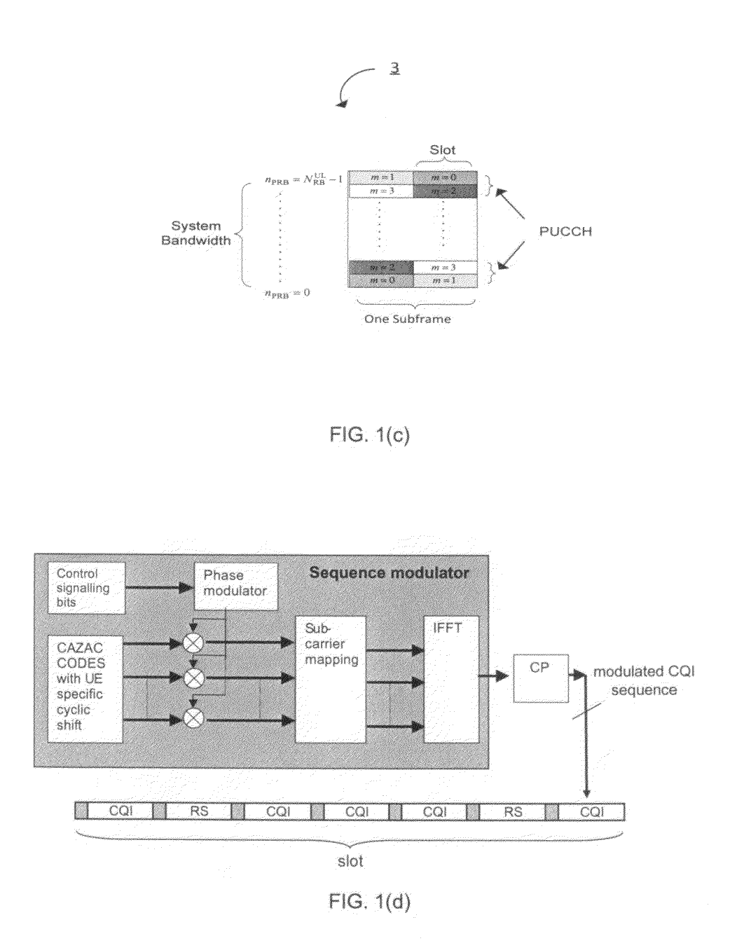

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as a Node B (base station), and more specifically an eNB 12. The network 1 may include a network control element (NCE) 14 that may include the MME/SGW functionality shown in FIG. 1A, and which provides connectivity with a further network, such as a telephone network and/or a data communications network (e.g., the internet). The UE 10 includes a controller, such as at least one computer or a data processor (DP) 10A, at least one non-transitory computer-readable memory medium embodied as a memory (MEM) 10B that stores a program of computer instructions (PROG) 10C, and at least one suitable radio frequency (RF) transmitter/receiver pair (transceiver) 10D for bidirectional wireless communications with the eNB 12 via one or more antennas. The eNB 12 also includes a controller, such as at least one computer or a data processor (DP) 12A, at least one computer-readable memory medium embodied as a memory (MEM) 12B that stores a program of computer instructions (PROG) 12C, and at least one suitable RF transceiver 12D for communication with the UE 10 via one or more antennas (typically several when multiple input/multiple output (MIMO) operation is in use). The eNB 12 is coupled via a data/control path 13 to the NCE 14. The path 13 may be implemented as the S1 interface shown in FIG. 1A. The eNB 12 may also be coupled to another eNB via data/control path 15, which may be implemented as the X2 interface shown in FIG. 1A.

For the purposes of describing the exemplary embodiments of this invention the UE 10 can be assumed to also include a CSI reporting function or module 10E that operates in accordance with the exemplary embodiments, and the eNB 12 includes a corresponding CSI report receiving function or module 12E.

At least one of the programs 10C and 12C is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by the DP 10A of the UE 10 and/or by the DP 12A of the eNB 12, or by hardware, or by a combination of software and hardware (and firmware). The above-referenced CSI reporting function or module 10E and the CSI report receiving function or module 12E can be implemented in whole or in part as computer program instructions, as hardware, or as a combination of computer program instructions and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer-readable memories 10B and 12B may be of any type suitable to the local technical environment and may be implemented using any suitable data storage technology, such as semiconductor based memory devices, random access memory, read only memory, programmable read only memory, flash memory, magnetic memory devices and systems, optical memory devices and systems, fixed memory and removable memory. The data processors 10A and 12A may be of any type suitable to the local technical environment, and may include one or more of general purpose computers, special purpose computers, microprocessors, digital signal processors (DSPs) and processors based on multi-core processor architectures, as non-limiting examples.

The exemplary embodiments of this invention provide in part a multiplexing/mapping technique that supports simultaneous transmission of ACK/NACK and CSI when carrier aggregation is in use.

In one aspect thereof the exemplary embodiments can be configured via higher layer signaling whether to drop (omit transmission of) CSI when it happens to coincide with ACK/NACK is a given subframe.

In another aspect thereof the exemplary embodiments operate so as to, if simultaneous transmission of ACK/NACK and CSI is enabled, to spatially bundle ACK/NACK bits for each carrier component (CC). In this case, if there are two ACK/NACK bits on a CC, a logical “AND” operation is applied to bundle the two ACK/NACK bits. Further, the ACK/NACK from a PCell is mapped into b(0), the ACK/NACK from an SCell is mapped into b(1), and if more than two CCs (i.e., multiple SCells) are configured, predefined CC-domain bundling is applied to limit the number of bits to two.

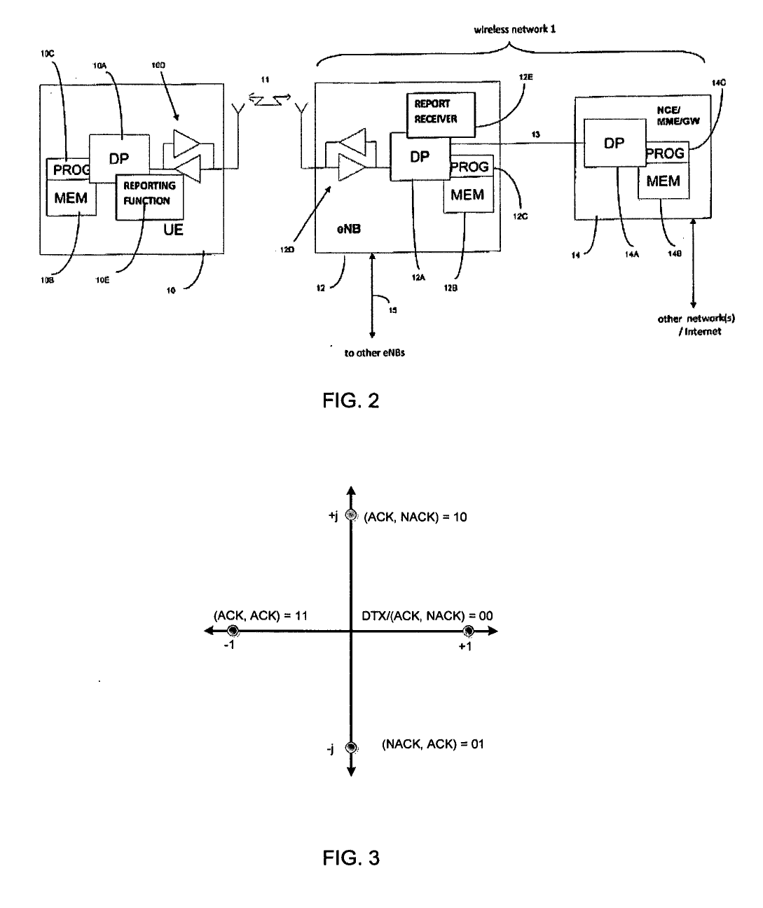

One example of predefined CC-domain bundling according to exemplary embodiments of the present invention is shown in, for example, FIG. 3(a). Alternatively, CC bundling in the case of more than two CCs can be either pre-defined as shown below in Table 1.11 or it can be configurable.

TABLE 1.11
Bundling rule for ACK/NACK bits from different CCs

| # of CCs | b(0) | b(1) |
|---|---|---|
| 2 | PCell | SCell1 |
| 3 | PCell | AND(SCell1, SCell2) |
| 4 | AND(PCell, Scell3) | AND(SCell1, SCell2) |
| 5 | AND(PCell, Scell3) | AND(SCell1, SCell2, SCell4) |

In the case where it is made configurable then dedicated radio resource control (RRC) signaling can be applied.

The two bundled ACK/NACK bits b(0) and b(1) are transmitted either by modulating the second RS block of the slot with a QPSK signal, or by using joint coding between CSI and ACK/NACK. PUCCH format 2b is used for the transmission of CSI and ACK/NACK when PUCCH format 1b channel selection and normal CP are configured. PUCCH format 2b can be used for the transmission of CSI and ACK/NACK also when PUCCH format 3 and normal CP are configured. Alternatively, it is possible to apply a DM RS modulation principle on the PUCCH format 3 channel for the ACK/NACK transmission and send the CSI using PUCCH format 3. This approach introduces a new modification of the PUCCH format 3 channel, (i.e. PUCCH format “3b”). Joint coding using the PUCCH format 2 channel is used when PUCCH format 3 or PUCCH format 1b channel selection and extended CP are configured.

In demodulation (DM) reference signal (RS) modulation ACK/NACK information is modulated in the RSs of the slot. This scheme is applied in exemplary embodiments of the current system for the second DM RS of the slot for the CQI RS in the case of normal CP and PUCCH format 2a/2b. The modulation itself follows the sequence modulation principle described above and shown in FIG. 1(d).

In the case of LTE TDD, where there may be several DL subframes to be ACK/NACKed in one UL subframe, further time domain bundling (TDB) can be performed.

In accordance with the exemplary embodiments of this invention a CSI reporting procedure executed by the CSI reporting module 10E proceeds as follows.

Each positive acknowledgement (ACK) is encoded as a binary ‘1’ and each negative acknowledgement (NACK) is encoded as a binary ‘0’. The bits b(0) and b(1) are determined according to bundling rules shown in Table 1 (depicted in Table 1.11 above) after first performing the spatial bundling described above. In the case of LTE TDD further Time Domain Bundling can be performed. In Table 1.11 the AND(X,Y) denotes a logical AND operation between ACK/NACK bits for cells X and Y. Recall that the truth table for an AND gate results in an output of an “1” if all inputs are “1,” else the output is “0.” As such, this mapping preserves the quality of the PCell ACK/NACK by minimizing the need for bundling with an odd number of CCs.

The bits b(0) and b(1) obtained from the Table 1.11 are then mapped onto modulation symbols of the second RS block in the PUCCH format 2b according to the Table 1.12 shown below or in the constellation mapping shown in FIG. 3.

TABLE 1.12
Mapping from b(0) and b(1) to modulation symbols of the 2nd
RS block in PUCCH format 2b

| | | | |
|---|---|---|---|
| Modulation of the | NACK, NACK | 00 | 1 |
| 2^{nd} RS block | NACK, ACK | 01 | −j |
| | ACK, NACK | 10 | +j |
| | ACK, ACK | 11 | −1 |

It is noted that NACK and discontinuous transmission (DTX) (i.e., where there no reason to include ACK/NACK feedback detected at the UE side) can share the same state.

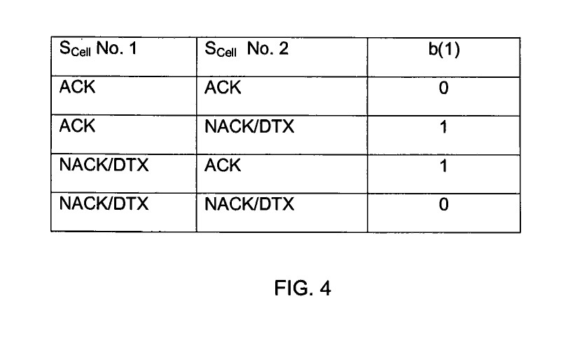

FIG. 4 illustrates an alternative option for the case of ACK/NACK bundling over the cells, where the ‘AND’ logical operation of Table 1.12 is replaced by cross-CC bundling. In this case the second bit (b(1) is used as an ACK counter according to the cross-CC bundling rules for a case of two SCells.

One clear and significant exemplary advantage and technical effect that is gained by the use of the exemplary embodiments is that the need for dropping CSI when it happens to coincide with ACK/NACK is avoided. This allows for better utilization of the CSI resulting in more accurate link adaptation and gains from channel-aware scheduling. Another advantage is that the same principle can be applied for both ACK/NACK signaling types, channel selection and PUCCH Format 3.

Based on the foregoing it should be apparent that the exemplary embodiments of this invention provide a method, apparatus and computer program(s) to provide enhanced channel state information reporting in a system using carrier aggregation.

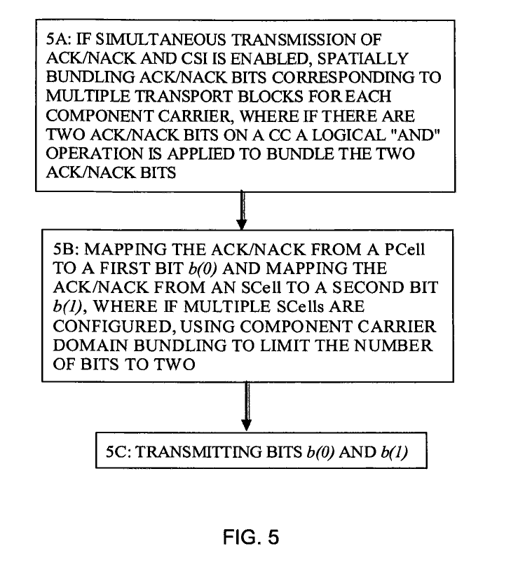

FIG. 5 is a logic flow diagram that illustrates the operation of a method, and a result of execution of computer program instructions, in accordance with the exemplary embodiments of this invention. In accordance with these exemplary embodiments a method performs, at Block 5A, a step of, if simultaneous transmission of ACK/NACK and channel state information is enabled, spatially bundling ACK/NACK bits corresponding to multiple transport blocks for each component carrier, where if there are two ACK/NACK bits on a CC a logical “AND” operation is applied to bundle the two ACK/NACK bits. At Block 5B there is a step of mapping the ACK/NACK from a PCell to a first bit b(0) and mapping the ACK/NACK from an SCell to a second bit b(1), where if multiple SCells are configured, using component carrier domain bundling to limit the number of bits to two. At Block 5C there is a step of transmitting bits b(0) and b(1).

In the method of FIG. 5, where bits b(0) and b(1) are transmitted by modulating a second reference symbol block of a slot with a QPSK signal.

In the method of FIG. 5, where bits b(0) and b(1) are transmitted by using joint coding between channel state information and ACK/NACK.

In the method of FIG. 5, where PUCCH format 2b is used when transmitting channel state information and ACK/NACK when PUCCH format 1b channel selection and normal cyclic prefix are configured.

In the method of FIG. 5, where PUCCH format 2b is used when transmitting channel state information and ACK/NACK when PUCCH format 3 and normal cyclic prefix are configured.

In the method of FIG. 5, where DM reference symbol modulation is performed on a PUCCH format 3 channel for the ACK/NACK transmission and where the channel state information is transmitted using PUCCH format 3.

In the method of FIG. 5, where joint coding using a PUCCH format 2 channel is used when PUCCH format 3 or PUCCH format 1b channel selection and extended cyclic prefix are configured.

In the method of FIG. 5, where each positive acknowledgment (ACK) is encoded as a binary ‘1’ and each negative acknowledgement (NACK) is encoded as a binary ‘0’, and where for a case of two component carriers b(0) conveys ACK/NACK indications for the PCell and b(1) conveys ACK/NACK indications for the SCell; and where for a case of three component carriers b(0) conveys ACK/NACK indications for the PCell and b(1) conveys logically ANDed ACK/NACK indications for SCell No. 1 and for SCell No. 2; and where for a case of four component carriers b(0) conveys logically ANDed ACK/NACK indications for the PCell and for SCell 3 and b(1) conveys logically ANDed ACK/NACK indications for SCell No. 1 and for SCell No. 2; and where for a case of five component carriers b(0) conveys logically ANDed ACK/NACK indications for the PCell and for SCell 3 and b(1) conveys logically ANDed ACK/NACK indications for SCell1, for SCell2 and for SCell4.

In the method of FIG. 5 and the preceding paragraph, where instead of b(1) conveying the logically ANDed ACK/NACK indications for SCell and for SCell2 bit b(1) instead functions as an ACK counter in accordance with the following cross-CC bundling rules:
(1) If the first secondary cell and the second secondary cell convey a positive acknowledgement, b(1) is equal to binary 0;
(2) If the first secondary cell contain a positive acknowledgement and the second secondary cell convey a negative acknowledge or discontinuous transmission, b(1) is equal to binary 1;
(3) If the first secondary cell contain a negative acknowledge or discontinuous transmission and the second secondary cell convey a positive acknowledgement, b(1) is equal to binary 1; and
(4) If the first secondary cell contain a negative acknowledge or discontinuous transmission and the second secondary cell convey a negative acknowledge or discontinuous transmission, b(1) is equal to binary 0;

In the method of FIG. 5, where each positive acknowledgment (ACK) is encoded as a binary ‘1’ and each negative acknowledgment (NACK) is encoded as a binary ‘0’, and where bits b(0) and b(1) are transmitted by modulating a second reference symbol block of a slot with a QPSK signal in PUCCH format 2b as follows (and shown in FIG. 3):

| | | |
|---|---|---|
| NACK, NACK | 00 | 1 |
| NACK, ACK | 01 | −j |
| ACK, NACK | 10 | j |
| ACK, ACK | 11 | −1. |

The various blocks shown in FIG. 5 may be viewed as method steps, and/or as operations that result from operation of computer program code, and/or as a plurality of coupled logic circuit elements constructed to carry out the associated function(s).

The exemplary embodiments also encompass a non-transitory computer-readable medium that contains software program instructions, where execution of the software program instructions by at least one data processor results in performance of operations that comprise execution of the method shown in FIG. 5 and in the foregoing several paragraphs that are descriptive of the method of FIG. 5.

The exemplary embodiments also encompass an apparatus that comprises a processor and a memory including computer program code. The memory and computer program code are configured to, with the processor, cause the apparatus at least, if simultaneous transmission of ACK/NACK and CSI is enabled, to spatially bundle ACK/NACK bits corresponding to multiple transport blocks for each component carrier, where if there are two ACK/NACK bits on a CC a logical “AND” operation is applied to bundle the two ACK/NACK bits, to map the ACK/NACK from a PCell to a first bit b(0) and map the ACK/NACK from an SCell to a second bit b(1), where if multiple SCells are configured, to use component carrier domain bundling to limit the number of bits to two; and to transmit bits b(0) and b(1).

The exemplary embodiments also encompass an apparatus that comprises means, responsive to simultaneous transmission of ACK/NACK and CSI being enabled, for spatially bundling ACK/NACK bits for each component carrier (e.g., reporting function 10E), where if there are two ACK/NACK bits on a CC a logical “AND” operation is applied to bundle the two ACK/NACK bits, means for mapping (e.g., reporting function 10E) the ACK/NACK from a PCell to a first bit b(0) and for mapping the ACK/NACK from an SCell to a second bit b(1), where if multiple SCells are configured, using component carrier domain bundling to limit the number of bits to two; and means for transmitting (e.g., reporting function 10E, transceiver 19D) bits b(0) and b(1).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the UTRAN LTE-A system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, means any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., CSI, CQI, PMI, RI, CP, etc.) are not intended to be limiting in any respect, as these parameters may be identified by any suitable names. Further, the various names assigned to different channels (e.g., PUCCH, PUCCH formats 1a, 1b, 2, 2a, 2b and 3 etc.) are not intended to be limiting in any respect, as these various channels/formats may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
enabling simultaneous transmission of a positive or negative acknowledge and channel state information; and
spatially bundling positive or negative acknowledge bits corresponding to multiple transport blocks for each of a plurality of component carriers,
where if there are two positive or negative acknowledge bits on a component carrier a logical “AND” operation is applied to bundle the two positive and negative acknowledge bits.

2. The method of claim 1, further comprising the step of:
mapping one or more positive or negative acknowledges from a primary cell to a first bit b(0);
mapping one or more positive or negative acknowledges from one or more secondary cells to a second bit b(1), where if more than one secondary cell is configured, using component carrier domain bundling to limit the number of bits to two; and
transmitting bits b(0) and b(1).

3. The method of claim 2, where bits b(0) and b(1) are transmitted by modulating a second reference symbol block of a slot with a quadrature phase shift keying signal.

4. The method of claim 2, where bits b(0) and b(1) are transmitted by using joint coding between channel state information and positive or negative acknowledges.

5. The method of claim 2, where physical uplink control channel format 2b is used when transmitting channel state information and positive or negative acknowledge when physical uplink control channel format 1b channel selection and normal cyclic prefix are configured.

6. The method of claim 5, where physical uplink control channel format 2b is used when transmitting channel state information and positive or negative acknowledges when physical uplink control channel format 3 and normal cyclic prefix are configured.

7. The method of claim 5, where demolutation reference symbol modulation is performed on a physical uplink control channel format 3 for positive or negative acknowledges transmission and where the channel state information is transmitted using physical uplink control channel format 3.

8. The method of claim 5, where joint coding using a physical uplink control channel format 2 channel is used when physical uplink control channel format 3 or physical uplink control channel format 1b channel selection and extended cyclic prefix are configured.

9. (canceled)

10. The method of claim 5, where for a case of two component carriers b(0) conveys positive or negative acknowledgments indications for the primary cell and b(1) conveys positive or negative acknowledgments indications for the secondary cell and where for a case of three component carriers b(0) conveys positive or negative acknowledgments indications for the primary cell and b(1) conveys logically ANDed positive or negative acknowledgments indications for a first secondary cell and second secondary cell and where for a case of four component carriers b(0) conveys logically ANDed positive or negative acknowledgments indications for the primary cell and for a third secondary cell and b(1) conveys logically ANDed positive or negative acknowledgments indications for the first secondary cell and for the second secondary cell and where for a case of five component carriers b(0) conveys logically ANDed positive or negative acknowledgments indications for the primary cell and for third secondary cell and b(1) conveys logically ANDed positive or negative acknowledgments indications for the first secondary cell, for the secondary cell and for fourth secondary cell.

11. The method of claim 10, where instead of b(1) conveying the logically ANDed positive or negative acknowledgments indications for the first secondary cell and for the second secondary cell bit b(1) instead functions as a positive acknowledgement counter, said positive acknowledgement counter configured to determine:
if the first secondary cell and the second secondary cell convey a positive acknowledgement, b(1) is equal to binary 0;
if the first secondary cell contain a positive acknowledgement and the second secondary cell convey a negative acknowledge or discontinuous transmission, b(1) is equal to binary 1;
if the first secondary cell contain a negative acknowledge or discontinuous transmission and the second secondary cell convey a positive acknowledgement, b(1) is equal to binary 1; and
if the first secondary cell contain a negative acknowledge or discontinuous transmission and the second secondary cell convey a negative acknowledge or discontinuous transmission, b(1) is equal to binary 0;

12. The method of claim 10, where each positive acknowledgment is encoded as a binary ‘1’ and each negative acknowledgment is encoded as a binary ‘0’, and where bits b(0) and b(1) are transmitted by modulating a second reference symbol block of a slot with a quadrature phase shift keying signal in physical uplink control channel format 2b,
wherein, if bits b(0) and b(1) both contain negative acknowledgements, map to the first quadrant, if bit b(0) contains a negative acknowledgement and bit b(1) a positive acknowledgement, map to the second quadrant, if bit b(0) contains a positive acknowledgement and bit b(1) a negative acknowledgement, map to the fourth quadrant, if bits b(0) and b(1) both contain positive acknowledgements, map to the third quadrant.

13. An apparatus, comprising:
at least one processor; and
at least one memory storing a computer program in which the at least one memory with the computer program is configured with the at least one processor to cause the apparatus to at least:
enable simultaneous transmission of a positive or negative acknowledge and channel state information; and
spatially bundling positive or negative acknowledge bits corresponding to multiple transport blocks for each of a plurality of component carriers,
where if there are two positive or negative acknowledge bits on a component carrier a logical “AND” operation is applied to bundle the two positive and negative acknowledge bits.

14. The apparatus of claim 13, further configured to at least:
map one or more positive or negative acknowledges from a primary cell to a first bit b(0);
map one or more positive or negative acknowledges from one or more secondary cells to a second bit b(1), where if more than one secondary cell is configured, using component carrier domain bundling to limit the number of bits to two; and
transmit bits b(0) and b(1).

15. The apparatus of claim 14, where bits b(0) and b(1) are transmitted by modulating a second reference symbol block of a slot with a quadrature phase shift keying signal.

16. The apparatus of claim 14, where bits b(0) and b(1) are transmitted by using joint coding between channel state information and positive or negative acknowledges.

17. The apparatus of claim 14, where physical uplink control channel format 2b is used when transmitting channel state information and positive or negative acknowledge when physical uplink control channel format 1b channel selection and normal cyclic prefix are configured.

18. The apparatus of claim 17, where physical uplink control channel format 2b is used when transmitting channel state information and positive or negative acknowledges when physical uplink control channel format 3 and normal cyclic prefix are configured.

19. The apparatus of claim 17, where demodulation reference symbol modulation is performed on a physical uplink control channel format 3 for positive or negative acknowledges transmission and where the channel state information is transmitted using physical uplink control channel format 3.

20. The apparatus of claim 17, where joint coding using a physical uplink control channel format 2 channel is used when physical uplink control channel format 3 or physical uplink control channel format 1b channel selection and extended cyclic prefix are configured.

21. (canceled)

22. The apparatus of claim 17, where for a case of two component carriers b(0) conveys positive or negative acknowledgments indications for the primary cell and b(1) conveys positive or negative acknowledgments indications for the secondary cell and where for a case of three component carriers b(0) conveys positive or negative acknowledgments indications for the primary cell and b(1) conveys logically ANDed positive or negative acknowledgments indications for a first secondary cell and second secondary cell and where for a case of four component carriers b(0) conveys logically ANDed positive or negative acknowledgments indications for the primary cell and for a third secondary cell and b(1) conveys logically ANDed positive or negative acknowledgments indications for the first secondary cell and for the second secondary cell and where for a case of five component carriers b(0) conveys logically ANDed positive or negative acknowledgments indications for the primary cell and for third secondary cell and b(1) conveys logically ANDed positive or negative acknowledgments indications for the first secondary cell, for the secondary cell and for fourth secondary cell.

23. The apparatus of claim 17, where instead of b(1) conveying the logically ANDed positive or negative acknowledgments indications for the first secondary cell and for the second secondary cell bit b(1) instead functions as a positive acknowledgement counter, said positive acknowledgement counter configured to determine:
if the first secondary cell and the second secondary cell convey a positive acknowledgement, b(1) is equal to binary 0;
if the first secondary cell contain a positive acknowledgement and the second secondary cell convey a negative acknowledge or discontinuous transmission, b(1) is equal to binary 1;
if the first secondary cell contain a negative acknowledge or discontinuous transmission and the second secondary cell convey a positive acknowledgement, b(1) is equal to binary 1; and
if the first secondary cell contain a negative acknowledge or discontinuous transmission and the second secondary cell convey a negative acknowledge or discontinuous transmission, b(1) is equal to binary 0;

24. The method of claim 17, where each positive acknowledgment is encoded as a binary ‘1’ and each negative acknowledgment is encoded as a binary ‘0’, and where bits b(0) and b(1) are transmitted by modulating a second reference symbol block of a slot with a quadrature phase shift keying signal in physical uplink control channel format 2b,
wherein, if bits b(0) and b(1) both contain negative acknowledgements, map to the first quadrant, if bit b(0) contains a negative acknowledgement and bit b(1) a positive acknowledgement, map to the second quadrant, if bit b(0) contains a positive acknowledgement and bit b(1) a negative acknowledgement, map to the fourth quadrant, if bits b(0) and b(1) both contain positive acknowledgements, map to the third quadrant.

25. A program storage device readable by a machine, tangibly embodying a program of instructions executable by the machine for performing operations, said operations comprising:
enabling simultaneous transmission of a positive or negative acknowledge and channel state information; and
spatially bundling positive or negative acknowledge bits corresponding to multiple transport blocks for each of a plurality of component carriers,
where if there are two positive or negative acknowledge bits on a component carrier a logical “AND” operation is applied to bundle the two positive and negative acknowledge bits.

26-48. (canceled)
